(19) United States
(12) Patent Application Publication
(10) Pub. No.: US 2013/0259325 A1
(43) Pub. Date: Oct. 3, 2013

(54) ACCESS CONTROL ARRANGEMENT SYSTEM AND ITS APPARATUS

(71) Applicant: UTECHZONE CO., LTD., New Taipei City (TW)

(72) Inventor: Chia-Chun TSOU, New Taipei City (TW)

(73) Assignee: UTECHZONE CO., LTD., New Taipei City (TW)

(21) Appl. No.: 13/715,593

(22) Filed: Dec. 14, 2012

(30) Foreign Application Priority Data
Mar. 30, 2012 (TW) 101111307

(51) Int. Cl. G06K 9/00

(52) U.S. Cl. CPC G06K 9/00302; G06K 9/00221
USPC 382/118; 382/115

(57) ABSTRACT

The invention provides an access control arrangement system and its apparatus. It takes the limitation of space and synchronous operation to ensure that at least two types of control elements, such as biological traits that cannot be counterfeited and allotment identity control card, are combined safely as a trusted base for follow-up management and service. The apparatus disclosed by the present invention mainly comprises an access card reading module and an image recording device that takes facial image simultaneously. Therefore, it can be operated in the limited space such as turnstiles or passageways to complete synchronous operation and safely and seamless information connection.

### FIELD OF THE INVENTION

The present invention relates to an access control arrangement system that controls the connection and the separation of information, and more particularly to a seamless access control arrangement system that combines multiple control elements simultaneously through its continuity of time and limitation on space in operation.

### BRIEF DESCRIPTION OF THE PRIOR ART

The simplest way to regulate individuals entering and exiting a building is to set an access control system in the entrance. Take research institutes as an example, to protect research findings of a laboratory, the researchers are required to carry access cards with them. When a researcher wants to enter a laboratory, he has to hold his access card close to the access control system and then enters the laboratory after the machine confirms the access card. However, the drawback of this method is that if a researcher loses his access card, then anyone who finds the lost access card can enter the laboratory freely.

To amend the drawback, many techniques are developed and hold into practice on various important facilities. For instance, U.S. Pat. No. 6,744,462 discloses “Apparatus and methods for resolution of entry/exit conflicts for security monitoring systems.” This technique can record the images of passing individuals and then analyzes the images to check the identities of the individuals with specific human face identification software.

Another instance is U.S. Pat. No. 7,986,816, which discloses “Methods and systems for multiple factor authentication using gaze tracking and iris scanning” as another solution. The main technical characteristic of U.S. Pat. No. 7,986,816 is recording human eyes with camera and then checking the images of irises and the movements of eyeballs. Because everyone has different irises and unique eyeball movements, only individuals that have been approved by the management center and have gone through registration programs like eyeball check can pass. This patent focuses on the special algorithm that checks the recorded eyeball movements.

The above two patents provide different techniques respectively to strengthen the security performance of access control, wherein the eyeball movement checking technique of U.S. Pat. No. 7,986,816 even enhanced the access control security to a high level of accuracy. Frankly speaking, access card identification, human face identification, and eyeball movement checking technique all operate reasonably well and have certain effects. However, the drawback of access card identification is that it only identifies with the card and not with the individual; whoever has the card can pass through the access control. Moreover, the eyeball movement checking technique as disclosed by U.S. Pat. No. 7,986,816 requires appropriate equipments to operate. Its high accuracy is a favorable advantage, yet if there are hundreds of entrances in a building and all of them are required to install the same equipment, it will be quite a sum to complete all these installations. Besides, whether in the above-mentioned apparatus or the current access control management systems, the management center always has to register or login the correspondence between the access card (or the user data) and the individual in advance to begin its control; in other words, all the management centers cannot control without time gaps and therefore they are all flawed in controlling the access of individuals. These are the long-pending problems inside the current control systems that should be excluded.

### SUMMARY OF THE INVENTION

The purpose of the invention is to provide a continuous personnel access control apparatus, which features a technique of individual-card integration and which has many advantages like no time gaps, synchronous operations, and full usage of the limitations of space to improve the personnel access control.

One aspect of the invention is to provide an access control arrangement system, comprising an access control apparatus and an external personnel control central system, in coordination with an identity control card which a user carries to control the opening and the shutting of a turnstile and which holds an access card identification data that corresponds with the turnstile. The access control apparatus comprises an access card reading module that reads the access card identification data of the identity control card, an image recording device that records an image of the user to acquire an user data while the access card reading module reads the access card identification data, and a data transmission module that electrically connects with the access card reading module and the image recording device to transmit the access card identification data and the user data to the external personnel control central system. The external personnel control central system establishes a correspondence between the access card identification data and the user data or removes the correspondence between the access card identification data and the user data.

Preferably, the external personnel control central system is capable of conducting the individual-card connection login process, which makes the access card identification data correspond with the user data, and the turnstile is for the passage of only one person per time.

Preferably, the external personnel control central system is capable of conducting the individual-card separation logout process, which removes the correspondence between the access card identification data and the user data.

Preferably, the image recording device is installed close to the access card reading module, or the image recording device is installed close to the turnstile.

Preferably, the user data is a facial image of the user.

Preferably, the access control apparatus further comprises a warning module, so that if the access card identification data do not correspond with the user data, the warning module will send out an alert message.

Another aspect of the invention is to provide an access control apparatus, which is fit for coordinating with an identity control card which a user carries and with an external personnel control central system for operation and used for controlling the opening and the shutting of a turnstile, wherein the identity control card holds an access card identification data that corresponds with the turnstile. The access control apparatus comprises: an access card reading module for reading the access card identification data of the identity control card, an image recording device that records an image of the user to acquire an user data while the access card reading module reads the access card identification data, and a data transmission module that electrically connects with the access card reading module and the image recording device to transmit the access card identification data and the user data to the external personnel control central system so that the external personnel control central system establishes or removes the correspondence between the access card identification data and the user data.

Preferably, the image recording device is installed close to the access card reading module, and the turnstile allows for the passage of only one person per time. Or, the image recording device is installed close to the turnstile.

Preferably, the user data is a facial image of the user.

Preferably, the access control apparatus further comprises a warning module, so that if the access card identification data do not correspond with the user data, the warning module will send out an alert message.

Preferably, the access control apparatus further comprises a lock control module that controls the opening and the shutting of the turnstile.

Another aspect of the invention is to provide an access control apparatus, which operates in coordination with an identity control card that a user carries, wherein the identity control card holds an access card identification data that corresponds with a turnstile; the access control apparatus comprises: an access card reading module for reading the access card identification data, an image recording device that records an image of the user to acquire an user data while the user passes through the turnstile that allows for the passage of only one person per time, and a data transmission module that electrically connects with the access card reading module and the image recording device to transmit the access card identification data and the user data to an external personnel control central system to make the access card identification data correspond with the user data or remove the correspondence between the access card identification data and the user data.

Preferably, the image recording device is installed close to the access card reading module, and the user data are a facial image of the user. Or, the image recording device is installed close to the turnstile, and the user data are a facial image of the user.

The benefit of the invention is that the access control arrangement system of the invention fully takes advantage of the limitation of space in front of turnstiles. The turnstiles allow for the passage of only one user per time; therefore, if the apparatus fails to acquire user images correctly or if there are two individuals that want to force through the entrance, the users will be judged by the apparatus as unable to attain valid data and thus denied accesses. The trait of limitation of space in front of turnstiles that the access control arrangement system of the invention utilizes can control the passing individuals effectively and accurately, excluding the possibility of counterfeiting.

Another important characteristic of the access control arrangement system of the invention is its operation mode that holds no time gaps and no leaks. When a user has his identity control card read, the device simultaneously acquires the user data. This is an immediate image recording action that is difficult to cheat. As a result, in addition to avoiding counterfeiting, the system also enhances the security level of the accuracy of connection between the identity control card and the user data.

The technique of the invention provides a more comprehensive and more effective personnel control ability without the need to change current access card system. The system or apparatus of the invention certainly is especially advantageous for public facilities and buildings that hold massive people flow and various entrances like large international airports, office buildings, shopping malls, museums, and amusement parks. Furthermore, comparing to the high costs of current techniques, the implementation costs of the invention is more reasonable and more competitive market-wise, which further highlights its unique technical traits and business achievements.

The invention completes dynamic individual-card login registration or logout separation based on the traditional access card techniques along with its own technique that simultaneously records human faces successively without time gaps, avoiding the human face registration and identification program of current techniques that requires complicated procedure or various tedious administrative login processes. Moreover, the invention conducts simultaneous image recording processes successively without time gaps, which further excludes possibilities of counterfeiting and cheating.

The access card of the invention is also reusable. In addition to the social responsibility of an enterprise to dedicate itself to environmental-friendly technology, the invention is also the only advanced design by far that holds multiple control elements and an automatic individual-card connecting or separating equipment without hampering the movements of individuals and without the need to add any administrative identification login program.

The system of the invention can also be modified according to the requirements for further expansion and upgrading in the future.

From the view of users, the invention is basically the same in manipulation as the traditional access cards. Comparing to the current techniques that require a back-office system to authenticate and conduct data registration, the invention has advantages for its quickness and simple manipulation.

The access control apparatus of the invention cooperates with the external personnel control central system to provide precise calculations of personnel flow and the located area, wherein counterfeiting and cheating can be prevented.

According to the access control apparatus disclosed by the invention, it mainly comprises an access card reading module that reads access card identification data, an image recording device that records the images of users as user data, and a data transmission module that transmits access card identification data and user data to the external personnel control central system, which establishes a correspondence between the access card identification data and the user data or otherwise removes the original correspondence.

### BRIEF DESCRIPTION OF THE FIGURES

The objects as well as the technical contents and features of the present invention will be best understood by referring to the following detailed description of a preferred embodiment in conjunction with the accompanying drawings, in which:

FIG. 1 is a schematic diagram of the access control apparatus of the invention.

FIG. 2 is a schematic diagram of the usage of the access control apparatus of the invention.

FIG. 3 is a schematic diagram of the access control arrangement system of the invention.

FIG. 4 is a schematic diagram of the composition of the access control arrangement system of the invention.

### DETAILED DESCRIPTION OF THE EMBODIMENTS

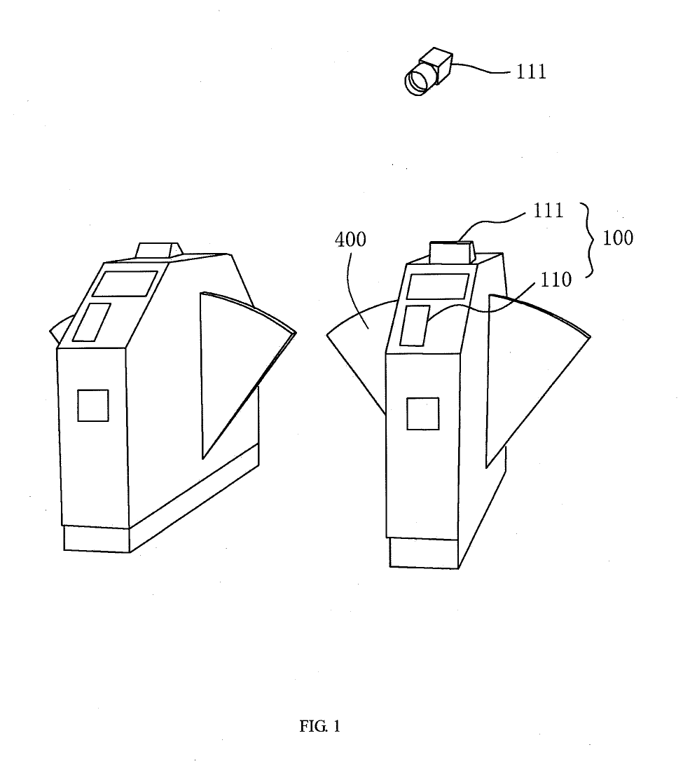

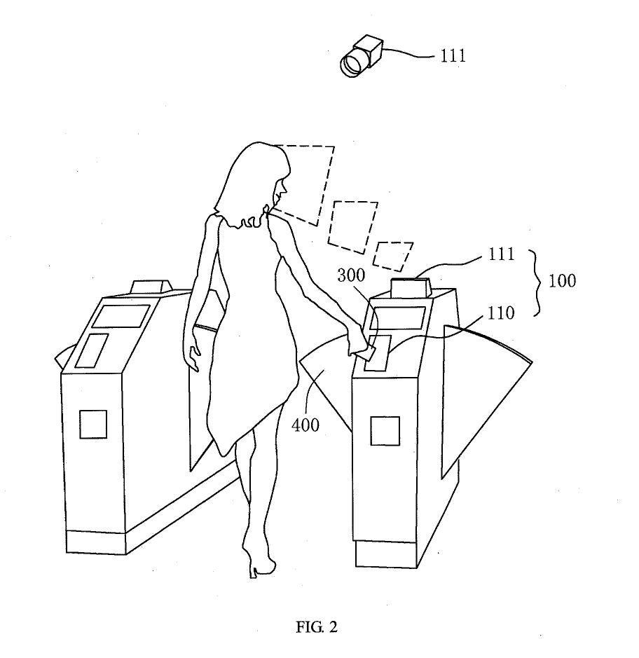

In regard to the access control arrangement system of the invention, first, please refer to FIG. 1 and FIG. 2 for illustrations. As FIG. 1 shows, the access control apparatus (100) is not different from traditional access control devices in terms of usage. A user (sometimes called the cardholder) carries an identity control card (300) and holds it close to an access card reading module (110) located at one side of the access control apparatus (100). At the moment the access card reading module (110) starts reading, an (111) records the images of the user as a user data. If the identity of the cardholder is correspondent with the identity control card (300), the turnstile (400) will open and allow the cardholder to pass. If it is the first usage, the (200) will conduct the individual-card login registration process and connect the identity control card (300) with the images of the cardholder. Afterwards, when the user passes through other turnstiles, the external personnel control central system will check every time whether the access card identification data are correspondent with the images of the user. If it is the last usage or the user is going to leave the building, the external personnel control central system (200) will not only check whether the access card identification data correspond with the images of the cardholder but also remove the correspondence between the access card identification data and the images of the cardholder. The identity control card can be retrieved and recycled. What should be added is that the image recording device (111) can be optionally installed close to the access card reading module (110). For example the image recording device (111) is embedded in access card reading module (110) but is slightly exposed to let the camera record the images of users as they have their identity control cards (300) read. Another way is to install the image recording device (111) on the ceiling, which can also record the images of users. The apparatus can also be designed so that if the camera cannot record clear images or cannot record images from the right angle, the user will be denied access until clear and correct user images are available. The illustrations above are only examples rather than limitations on the range of claim of the invention. In fact, there are still many other possible embodiments for the invention.

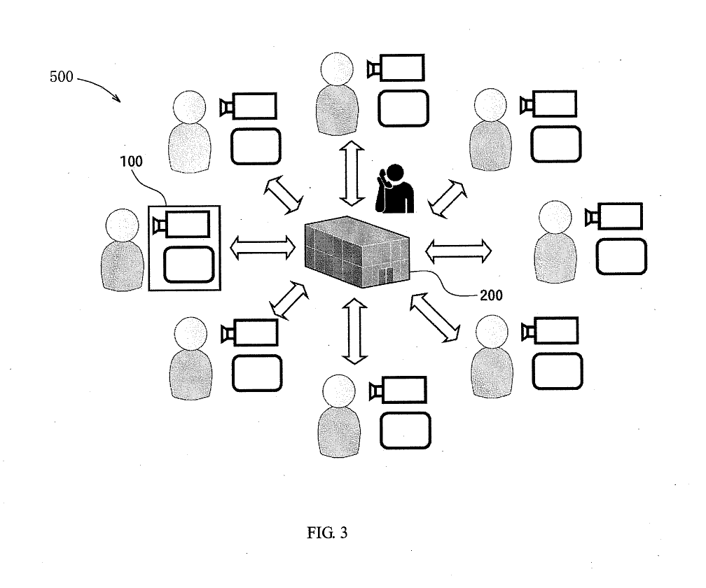

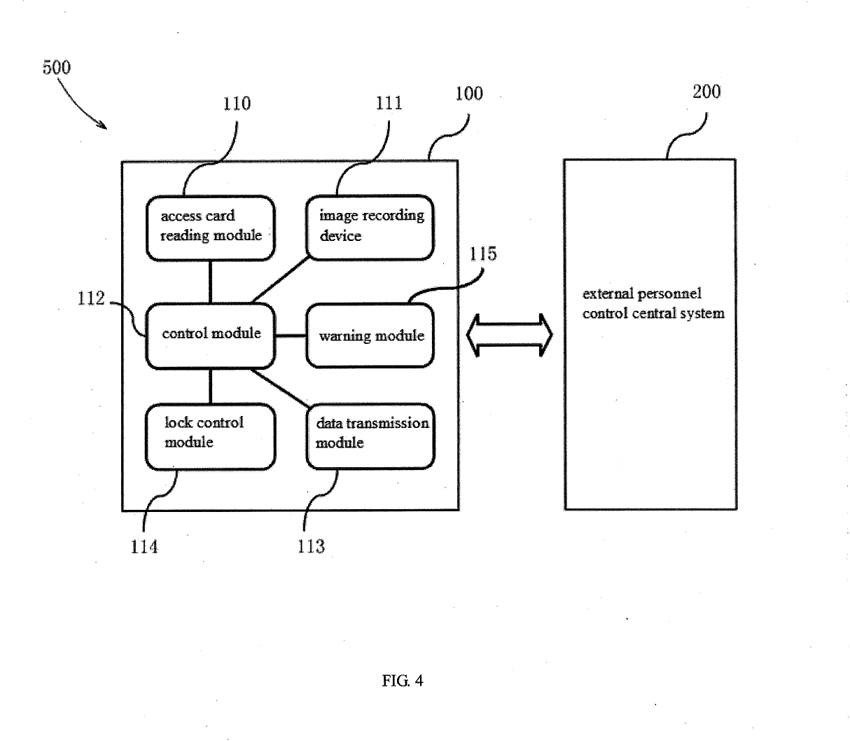

Please refer to FIG. 3 and FIG. 4 for illustrations on the configuration structure of the access control arrangement system (500), which comprise an access control apparatus (100) and an external personnel control central system (200) that cooperates with it. The external personnel control central system (200) can be a server. The access control apparatus (100) comprises an access card reading module (110), an image recording device (111), a control module (112), a data transmission module (113), a lock control module (114), and a warning module (115) that are electrically connected with each other directly or indirectly. Among them, the access card reading module (110) reads the access card identification data of an identity control card; the image recording device (111) records the images of a user to acquire the user data like facial images of a user; the data transmission module (113) transmits various data, messages, and commands to and from the external personnel control central system (200), wherein the data comprise the access card identification data and the user data mentioned above; the lock control module (114) operates according to the commands from the external personnel control central system (200), for instance, opening the turnstile (400) or keeping the turnstile (400) shut; the warning module (115) operates according to the commands from the external personnel control central system (200), and if the access card identification data are not correspondent with the user data, it will send out alert messages; the control module (112) is connected with all the preceding elements to control the production and the transmission of signals between each other.

The access control arrangement system (500) is suitable for gates or turnstiles that limit the passage to only one individual per time, wherein the limitation can be limits of space, for instance turnstiles at subway stations that allow the passage of only one passenger with one ticket per time. Another situation of limiting the passage to one person per time is embodied by the ticket checking mechanism of movie theaters. Entrances of movie theaters are generally larger to the extent that they can accommodate three to four people simultaneously; however, whether in practice or in regulation, movie theaters still require customers to queue orderly for admission, conforming to the limit of allowing only one person per ticket (card). In other words, the usage of the system or apparatus disclosed by the invention is based on the manner of allowing one person per ticket or one person per card whether the limits are set on space or in regulation. Allowing the passage of only one person per time does not limit the size of the turnstiles to be able of accommodating only one person.

The external personnel control central system (200) transmits data, commands, and various messages to the access control apparatus (100) by means of cable transmission or wireless transmission, and vice versa. The external personnel control central system stores access card identification data and user data transmitted from the access control apparatus (100) and conducts the connection login process between the two sets of data to make the access card identification data correspond with the user data or conducts the individual-card separation logout process to remove the correspondence between the access card identification data and the user data. The external personnel control central system (200) checks the conformity between an access card identification data and an user data; if there is a correspondence between them, it means that the user possesses the access card rightfully and legally, and commands will be transmitted to the lock control module (114) for opening; on the contrary, if there is no such correspondence, the turnstile (400) will keep shut and send alert messages to security guards. The external personnel control central system (200) can also analyze the user data and gain features of the user so as to quickly check the identity of the user along with report the location of the user.

For example, when a user carries an identity control card and holds it close to the access card reading module (110) at one side of the access control apparatus (100), the access card reading module (110) starts reading the access card identification data of the identity control card (300) and transmits them to the control module (112); before reading the access card identification data, the access card reading module (110) informs the control module (112) first so that when the control module (112) receives the information, the image recording device (111) will start recording user data like the facial images of a user and transmit them to the control module (112); then, the control module (112) will combine the access card identification data and the user data and transmit the combined data to the external personnel control central system (200) through the data transmission module (113).

The external personnel control central system (200) has a database for storing access card identification data, user data, and the correspondences between access card identification data and user data. When the external personnel control central system (200) receives a user data and an access card identification data from the access control apparatus (100), it checks whether there is a correspondence between the two data and whether this correspondence is valid through the database. If there is no such correspondence, it means that the user is using the apparatus for the first time, so the external personnel control central system (200) will establish a correspondence between the two sets of data, store the data in the database, and transmit an unlock command to the access control apparatus (100). When the lock control module (114) of the access control apparatus (100) receives the unlock command through the data transmission module (113) and the control module (112), it will accordingly change from the shut mode to the open mode and open the turnstile (400), allowing the user to pass instantly without the trouble of past programs that require registration beforehand, and therefore achieves the goals of simple manipulation and synchronous operation. Likewise, if there is a correspondence and the correspondence is valid, the external personnel control central system (200) will send out an unlock command to the access control apparatus (100) to accordingly open the turnstile (400). However, if the correspondence is invalid, for instance the user data from the related database corresponding with the access card identification data are not identical to the user data from the external personnel control central system (200), an alert command will be sent to the access control apparatus (100) and the lock control module (114) will keep in the shut mode, preventing the user from passing; at the same time, the warning module (115) of the access control apparatus (100) will receive an alert command through the data transmission module (113) and the control module (112) and accordingly send out alert messages to deter the cardholder and notify nearby security guards for disposal.

Each access control apparatus (100) has an exclusive identification code and corresponding position and these data are stored in the external personnel control central system (200) as well. When each access control apparatus (100) transmits access card identification data and user data, it also transmits its exclusive identification code. In this way, the external personnel control central system (200) can distinguish from which access control apparatus (100) the data are transmitted at the moment of reception, which can be used for further analyses and managements.

Besides, according to different installation locations, access control apparatuses (100) can be one-way entrances or one-way exits in or out a public facility, or gateways between different spaces inside a public facility, and surely this data is stored in the external personnel control central system (200) as well. If an access card is regulated for a single passage in and out a public facility, generally the external personnel control central system (200) will establish a correspondence between the access card identification data and the user data as the cardholder passes through the one-way entrance, and when the cardholder passes thorough the one-way exit, the external personnel control central system (200) will remove the correspondence between the access card identification data and the user data, letting the access card to be recycled and reused and avoiding repeated usage from other individuals. If an access card is regulated for a particular period (for example two days), the data of this usage period will be stored in the external personnel control central system (200) as well. When the cardholder first passes through the one-way entrance, the external personnel control central system (200) will establish a correspondence between the access card identification data and the user data and record the first usage time; afterwards, when the cardholder passes through the one-way exit, in addition to commanding the turnstile (400) to open, the external personnel control central system (200) will also check whether the interval between this usage time and the first usage time has passed beyond the permitted range; if so, the external personnel control central system (200) will remove the correspondence between the access card identification data and the user data.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An access control arrangement system, comprising an access control apparatus and an external personnel control central system, in coordination with an identity control card which a user carries to control the opening and the shutting of a turnstile and which holds an access card identification data that corresponds with the turnstile; the access control arrangement system is characterized in that:
the access control apparatus comprises an access card reading module that reads the access card identification data of the identity control card, an image recording device that records an image of the user to acquire an user data while the access card reading module reads the access card identification data, and a data transmission module that electrically connects with the access card reading module and the image recording device to transmit the access card identification data and the user data to the external personnel control central system; and
the external personnel control central system establishes a correspondence between the access card identification data and the user data or removes the correspondence between the access card identification data and the user data.

2. The access control arrangement system of claim 1, which is characterized in that: the external personnel control central system is capable of conducting the individual-card connection login process, which makes the access card identification data correspond with the user data, and the turnstile is for the passage of only one person per time.

3. The access control arrangement system of claim 1, which is characterized in that: the external personnel control central system is capable of conducting the individual-card separation logout process, which removes the correspondence between the access card identification data and the user data.

4. The access control arrangement system of claim 1, which is characterized in that: the image recording device is installed close to the access card reading module.

5. The access control arrangement system of claim. 1, which is characterized in that: the image recording device is installed close to the turnstile.

6. The access control arrangement system of claim 1, which is characterized in that: the user data is a facial image of the user.

7. The access control arrangement system of claim 1, which is characterized in that: the access control apparatus further comprises a warning module, so that if the access card identification data do not correspond with the user data, the warning module will send out an alert message.

8. An access control apparatus, which is fit for coordinating with an identity control card which a user carries and with an external personnel control central system for operation and used for controlling the opening and the shutting of a turnstile, wherein the identity control card holds an access card identification data that corresponds with the turnstile; the access control apparatus is characterized in that it comprises:
an access card reading module for reading the access card identification data of the identity control card,
an image recording device that records an image of the user to acquire an user data while the access card reading module reads the access card identification data, and
a data transmission module that electrically connects with the access card reading module and the image recording device to transmit the access card identification data and the user data to the external personnel control central system so that the external personnel control central system establishes or removes the correspondence between the access card identification data and the user data.

9. The access control apparatus of claim 8, which is characterized in that: the image recording device is installed close to the access card reading module, and the turnstile allows for the passage of only one person per time.

10. The access control apparatus of claim 8, which is characterized in that: the image recording device is installed close to the turnstile.

11. The access control apparatus of claim 8, which is characterized in that: the user data is a facial image of the user.

12. The access control apparatus of claim 8, which is characterized in that: the access control apparatus further comprises a warning module, so that if the access card identification data do not correspond with the user data, the warning module will send out an alert message.

13. The access control apparatus of claim 8, which is characterized in that: the access control apparatus further comprises a lock control module that controls the opening and the shutting of the turnstile.

14. An access control apparatus, which operates in coordination with an identity control card that a user carries, wherein the identity control card holds an access card identification data that corresponds with a turnstile; the access control apparatus is characterized in that it comprises:
an access card reading module for reading the access card identification data,
an image recording device that records an image of the user to acquire an user data while the user passes through the turnstile that allows for the passage of only one person per time, and
a data transmission module that electrically connects with the access card reading module and the image recording device to transmit the access card identification data and the user data to an external personnel control central system to make the access card identification data correspond with the user data or remove the correspondence between the access card identification data and the user data.

15. The access control apparatus of claim 14, which is characterized in that: the image recording device is installed close to the access card reading module, and the user data are a facial image of the user.

16. The access control apparatus of claim 14, which is characterized in that: the image recording device is installed close to the turnstile, and the user data are a facial image of the user.
